(19) United States
(12) Patent Application Publication
(10) Pub. No.: US 2004/0192324 A1
(43) Pub. Date: Sep. 30, 2004

(54) Communications network

(76) Inventor: Steven Rudkin, Ipswich (GB)

Correspondence Address: NIXON & VANDERHYE, PC, 1100 N GLEBE ROAD, 8TH FLOOR, ARLINGTON, VA, 22201-4714, US

(21) Appl. No.: 10/482,911

(22) PCT Filed: Jul. 17, 2002
(86) PCT No.: PCT/GB02/03298

(30) Foreign Application Priority Data
Jul. 17, 2001 (EP) 01306129.6

(51) Int. Cl. H04Q 7/20

(52) U.S. Cl. 455/452.2

(57) ABSTRACT

A method of generating data indicating the price a purchaser is willing to pay for the delivery of a content file to a receiver is disclosed. Conventionally, a purchaser has had to generate data representing his offer for each delivery. In the present invention, the offer data is generated on the basis of stored utility curves and values of utility-influencing parameters provided by the purchaser. This reduces the burden placed on the purchaser merely to the provision of providing utility-influencing parameters rather than the offer data itself.

The present invention relates to a communications network and to a method of operating a communications network.

Communications networks include many resources (such as memory in exchanges and capacity on links between exchanges) which are shared between the users of the network. There is a need to allocate those resources fairly amongst those users. Conventional telephony networks allocate a fixed amount of those resources to each user on a first-come-first-served basis.

In integrated networks (such as ATM networks and networks operating in accordance with the TCP/IP protocol suite), the problem of resource allocation is made more complex by different users using amounts of resource which vary between communications and even during a communication.

The paper “Distributed pricing for embedded ATM Networks” by J. Murphy, L. Murphy, E. C. Posner, in Proceedings of the International Teletraffic Congress ITC-14, Antibes, France, June 1994, suggests operating a network to calculate a price per unit bandwidth which reflects the level of usage of that network. The paper notes that where the time between price changes is short, users will not wish to negotiate for bandwidth manually. Instead, the paper suggests the user should program an intelligent network interface with a benefit function and their requirements for each type of service.

The above paper is one of several resource allocation schemes considered in a paper by S. Jordan and H. Jiang entitled “Connection establishment in high-speed networks,” IEEE Journal on Selected Areas in Communications, vol. 13, no. 7, pp. 1150-1161, Sept. 1995. Another of the resource allocation schemes considered there is “Pricing the Internet” by J. K. Mackie-Mason and H. R. Varian, in the Proceedings of the 2^{nd} International Conference on Telecommunications Systems Modelling, Nashville, Tennessee, Mar. 24-27, 1994, pp. 378-393. The system proposed therein involves users submitting a bid for network resources, the network thereafter accepting those bids that are higher than a market-clearing price it calculates on the basis of those bids.

The present inventors envisage that, in the field of content provision, it will often be the content provider or application provider which purchases the telecommunications service required to provide a client with a content file. In calculating the amount which it is prepared to pay, the content provider (or other purchaser) might consider, for example, characteristics of the client, characteristics of the content file and even the relationship between those sets of characteristics.

The present inventors have realised that a need will arise for a reduction in the burden placed on a purchaser in determining the price it is prepared to pay for different content file deliveries or for different calls.

According to the present invention, there is provided a method of operating a communications network to allocate resources of said network between users, said method comprising:

storing one or more sets of typical utility data for one or more types of said deliveries;

obtaining, from each of a plurality of users, values of one or more utility-influencing parameters for each of one or more data deliveries desired by said user;

generating resource demand data for each of said deliveries in dependence upon said stored typical utility data and said utility-influencing parameters; and

allocating the resources of said network between deliveries in dependence on said generated resource demand data.

By obtaining, from each of a plurality of users, utility-influencing parameters for each of their deliveries and using those parameters in combination with stored typical utility data for one or more types of deliveries to generate resource demand data for the users' deliveries and thereafter allocating resources on the basis of that resource demand data, a resource allocation scheme which is less burdensome to users than known market-based resource allocation schemes is provided.

In some embodiments said resource demand data comprises offer data. Market-based resource allocation schemes can work by having users bidding for network resources (such a bid being an example of offer data), the resources then being allocated by way of auction, or by advertising a price of network resources to users who then react by requesting an amount of bandwidth which is dependent on that price.

According to another aspect of the present invention, there is provided a method of generating offer data for a delivery of data across a communications network to a receiver, said method comprising:

storing one or more sets of utility data;

receiving values of one or more utility-influencing parameters associated with said delivery of data; and

generating said offer data in dependence upon said one or more sets of utility data and said one or more utility-influencing parameters.

By obtaining utility-influencing parameter values for a delivery of data from a purchaser and then generating an offer for said delivery based on stored utility data and said utility-influencing parameter values, the purchaser is required to provide utility-influencing parameter values rather than a set of utility data—the burden placed on the purchaser is therefore reduced. Utility is used here to mean the value the purchaser might place on the service for which an offer is being made.

In many embodiments, said data comprises content data. Content data includes video files, audio files, program files, web-pages and any other data which might be downloaded by a user.

In some embodiments, the offer generation involves processing at least one element of said set of utility data in a manner which depends upon one or more of said utility-influencing parameters. In other embodiments, a plurality of sets of utility data are stored and the offer generation involves: selecting one of said stored sets of utility data in dependence upon said utility-influencing parameter value; and generating said offer data from said selected set of utility data. In embodiments in which a plurality of utility-influencing parameters are specified, the offer generation might involve selection of a set of utility data on the basis of the value of one or more utility-influencing parameters and processing based on the value of other utility-influencing parameters.

In preferred embodiments, said delivery of data across said network is available at different qualities of delivery; each set of utility data enables the determination of utility values for each quality of delivery; and said offer data generation step involves: receiving one or more quality of delivery indications; and generating said offer data by determining a utility value for each indicated quality of delivery. In further preferred embodiments, said quality of delivery indications are obtained from metadata automatically generated at the time of generation of said content data.

Generating an offer for each of a plurality of quality of delivery indications, enables the most suitable of those offers to be selected in accordance with network conditions, and thereby allows the purchaser to increase the utility of one or more deliveries in comparison to the provision of only a single offer.

In preferred embodiments, at least two of said offers are processed to calculate a marginal value at which one offer should be replaced with another.

The utility-influencing parameters may either be continuous or discrete. Examples of utility-influencing parameters include the class to which a receiver is assigned, the commercial class into which the purchaser places the content data to be delivered (e.g. is it a recently released video / song and therefore temporarily of greater value), parameters which indicate the susceptibility of the delivery to a fall in the quality of the delivery—these include the format (e.g. coding scheme) of the content and the nature of the content (for example a sport video will rapidly be spoiled in comparison to a drama programme as the quality of delivery falls).

Preferably, said obtaining step comprises:

obtaining from said purchaser conversion data associating values of utility-influencing parameters with delivery characteristics derivable from a delivery request;

storing said conversion data; and

receiving a delivery request, and thereupon deriving said delivery characteristics and reading the values of utility-influencing parameters associated with said delivery characteristics.

By obtaining such conversion data and storing it for future use, the burden placed on the purchaser is significantly further reduced.

According to another aspect of the present invention, there is provided communications network operable to deliver content files from one or more file sources to one or more receivers, said network comprising:

one or more stores storing content files;

a store storing one or more sets of utility data;

means arranged in operation to find one or more utility-influencing parameter values associated with a delivery of a content file to one or more receivers; and

means arranged in operation to generate offer data from said one or more sets of utility data and said one or more utility-influencing parameters.

By way-of example only, specific embodiments of the present invention will now be described with reference to the accompanying Figures in which:

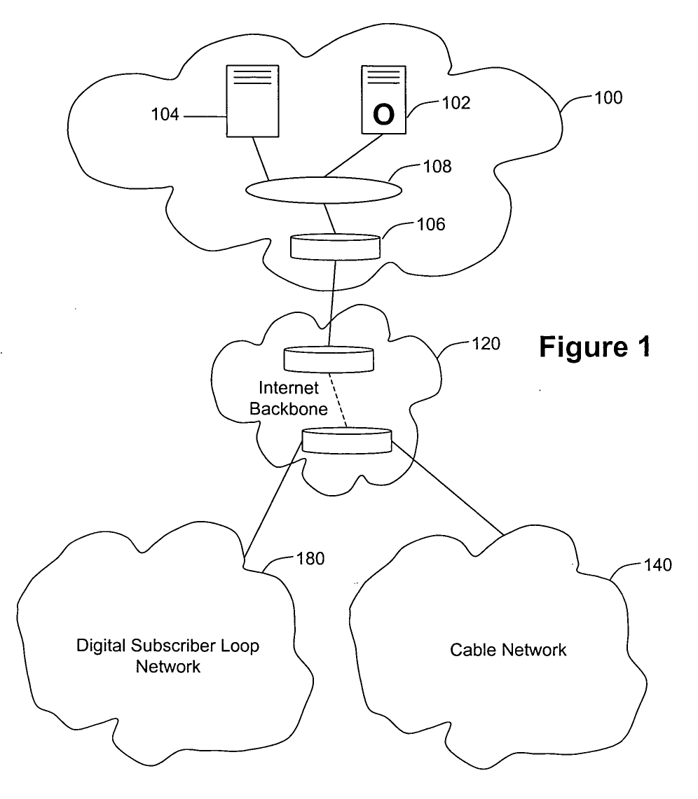

FIG. 1 shows an internetwork in which a first embodiment of the present invention is implemented;

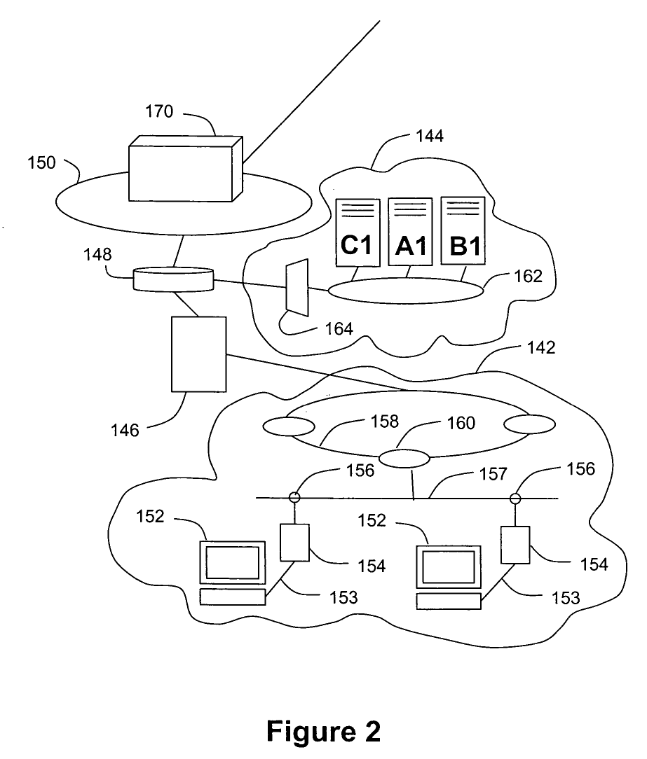

FIG. 2 shows a regional cable network portion of the internetwork of FIG. 1 in more detail;

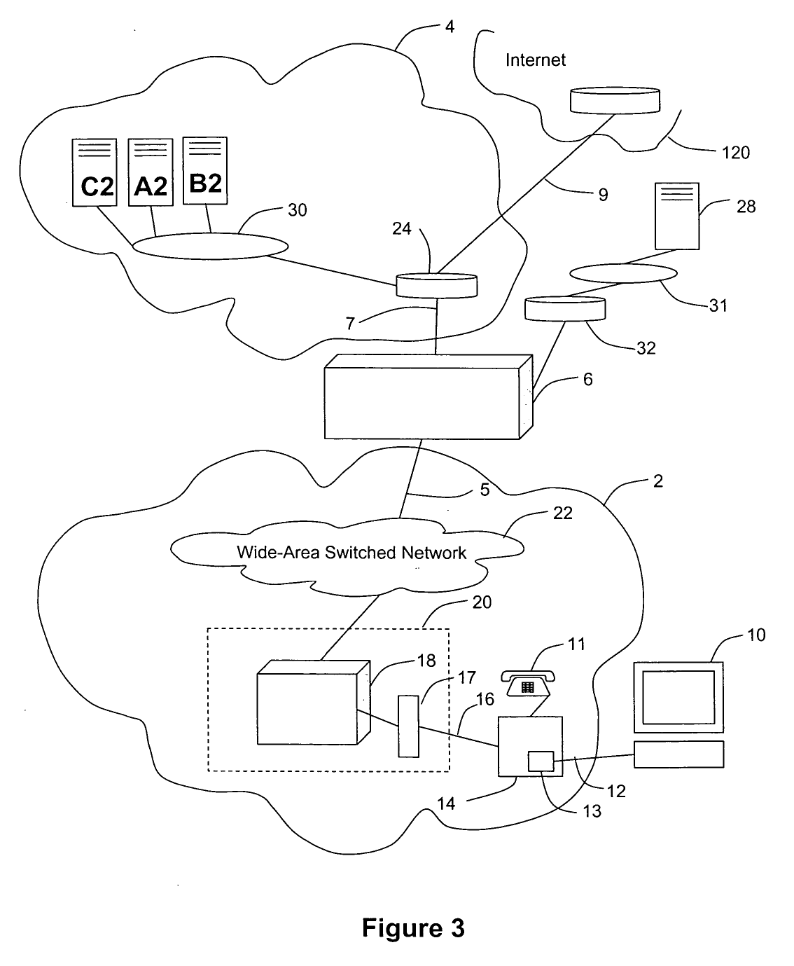

FIG. 3 shows a regional Digital Subscriber Loop network portion of the internetwork of FIG. 1 in more detail;

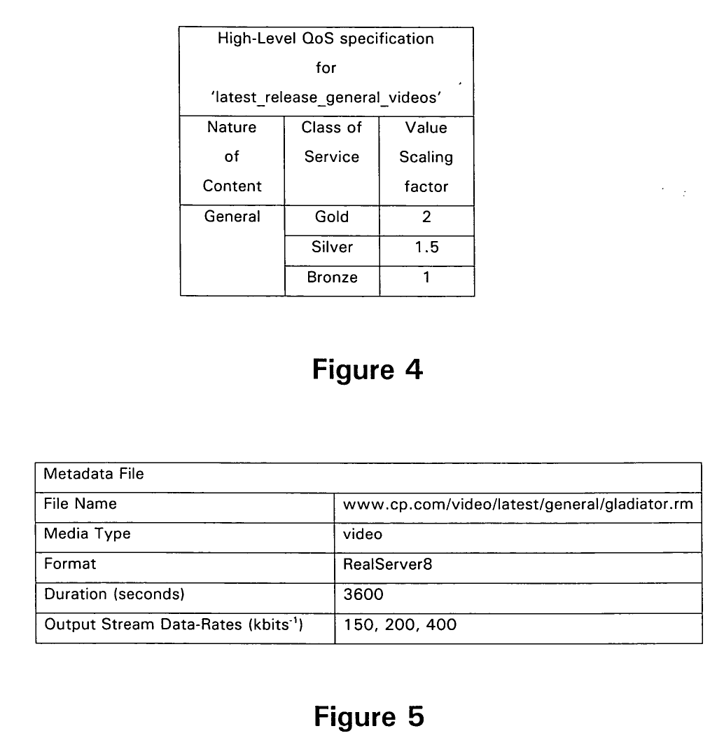

FIG. 4 shows data generated by the content provider in relation to one commercial class of content file;

FIG. 5 shows metadata stored together with a content file;

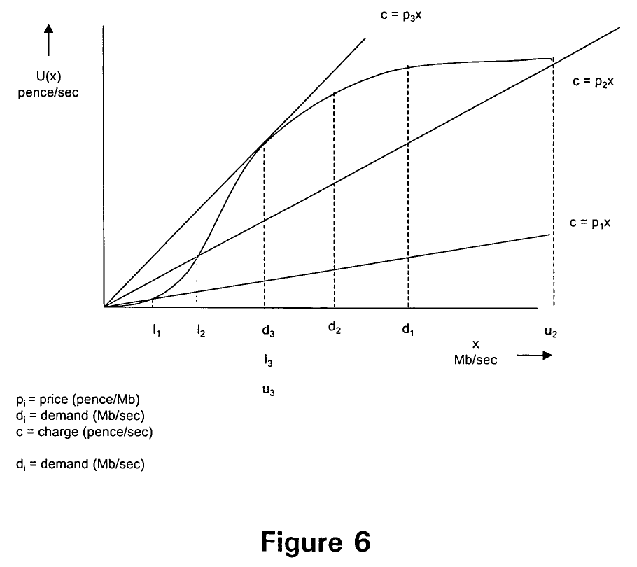

FIG. 6 shows a utility curve which illustrates how the value of bandwidth varies with the amount of bandwidth provided;

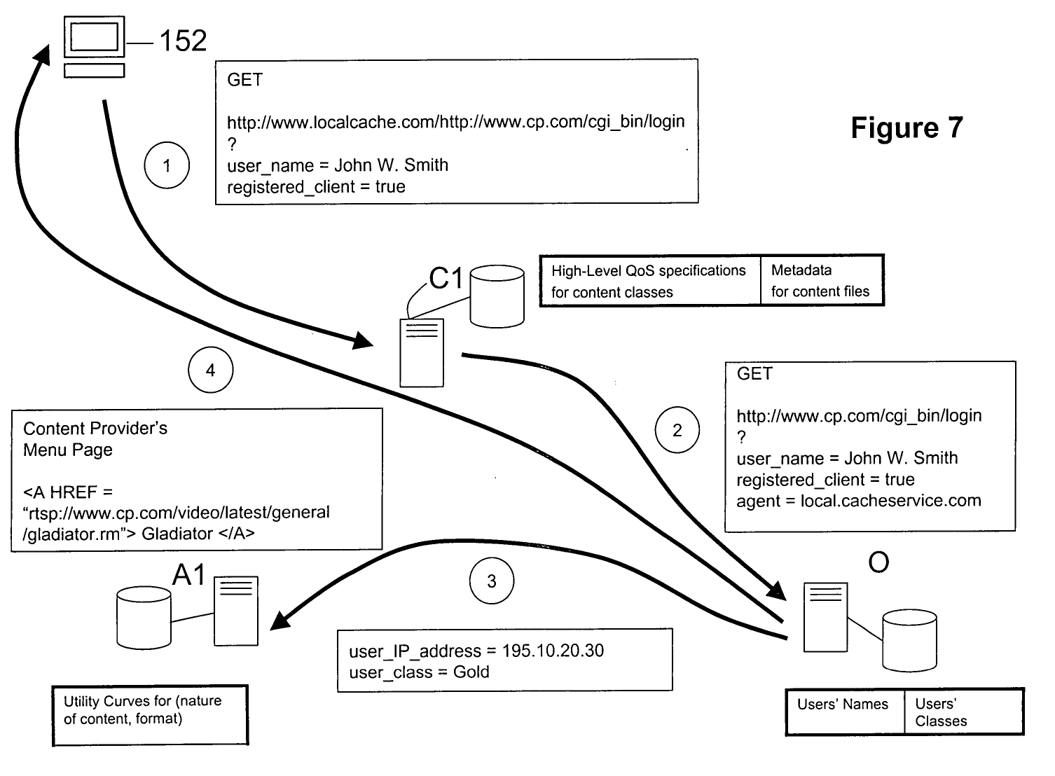

FIG. 7 shows the flow of messages between different devices of FIG. 1 in a session initiation phase of the first embodiment;

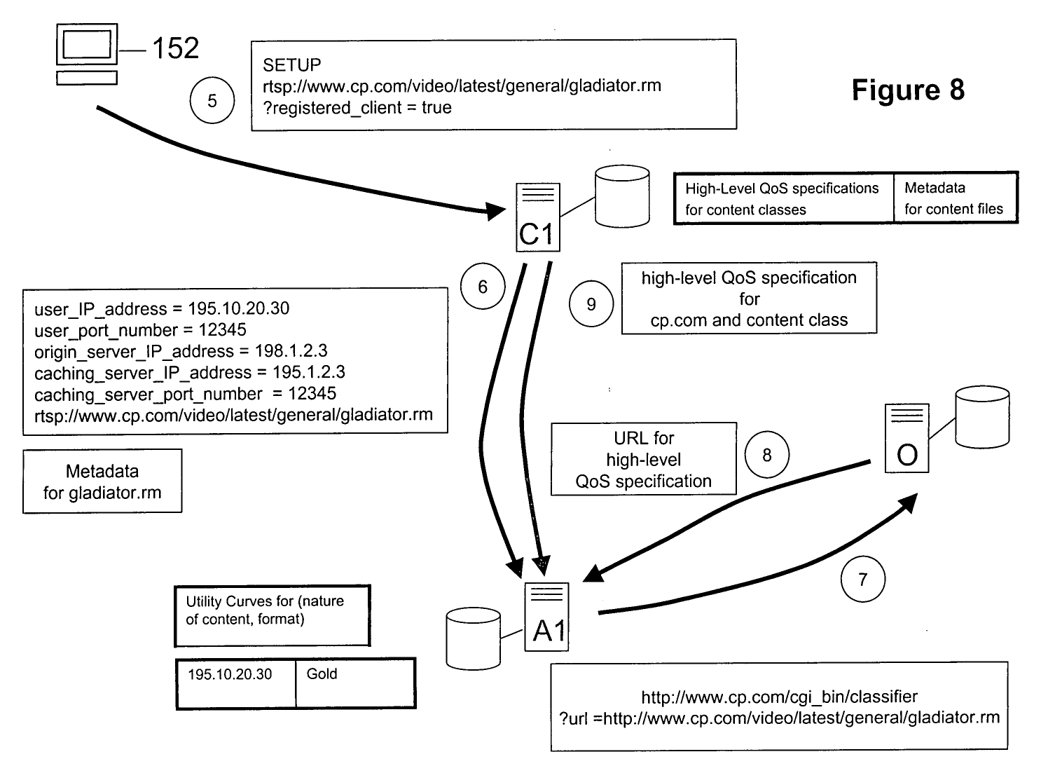

FIG. 8 shows the flow of messages between different devices of FIG. 1 in a first part of a content file request phase of the first embodiment;

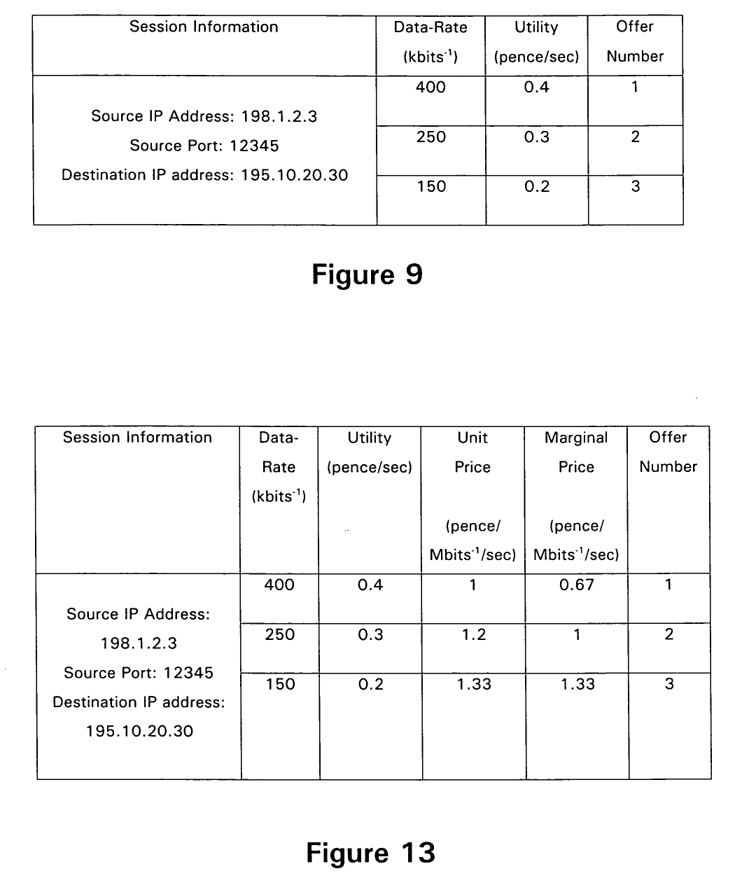

FIG. 9 shows offer data generated following the first part of a content file request phase of the first embodiment;

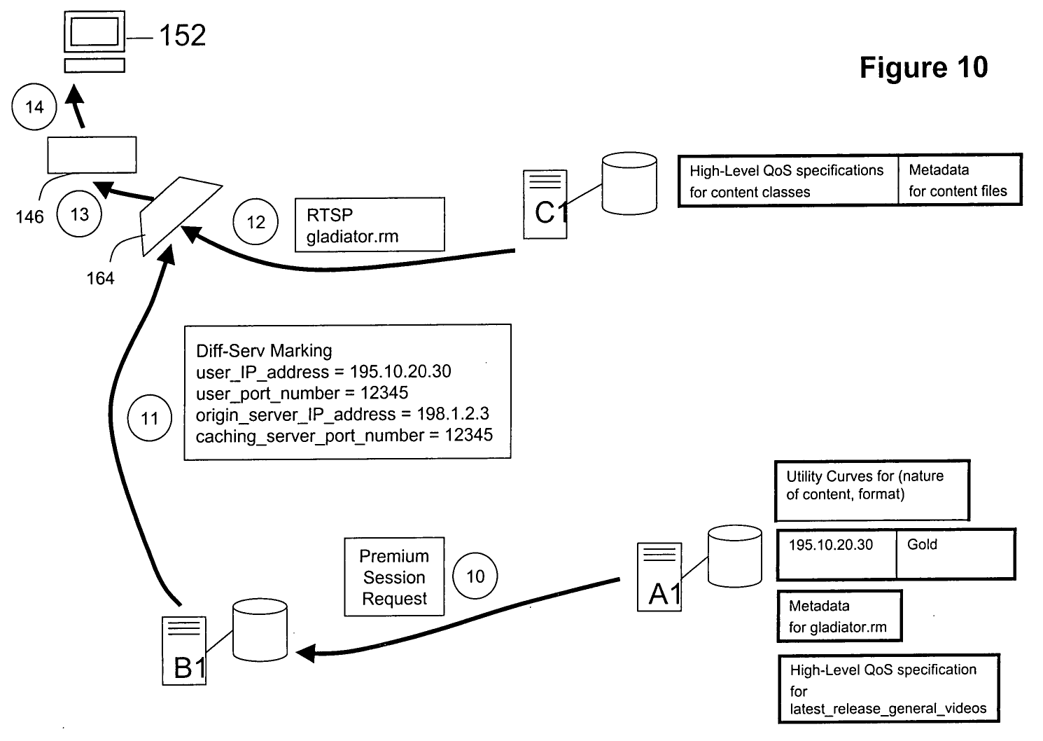

FIG. 10 shows the flow of messages between different devices of FIG. 1 in a second part of a content file request phase of the first embodiment;

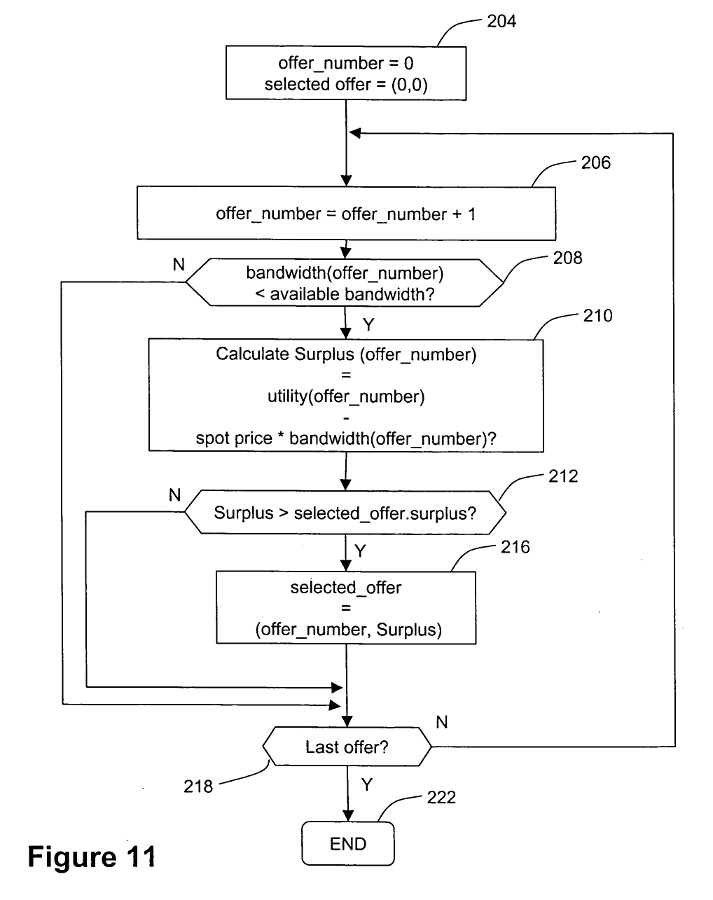

FIG. 11 shows an offer selection process;

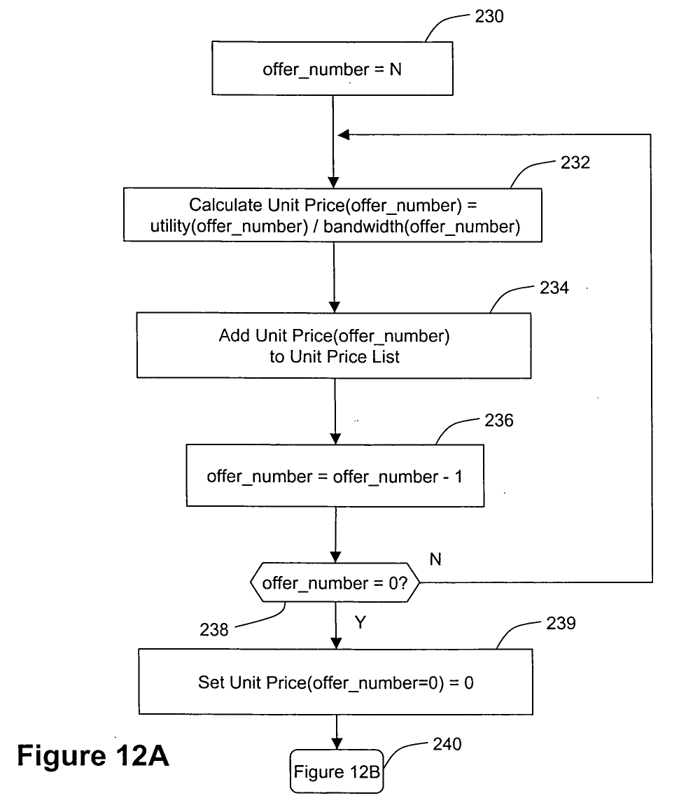

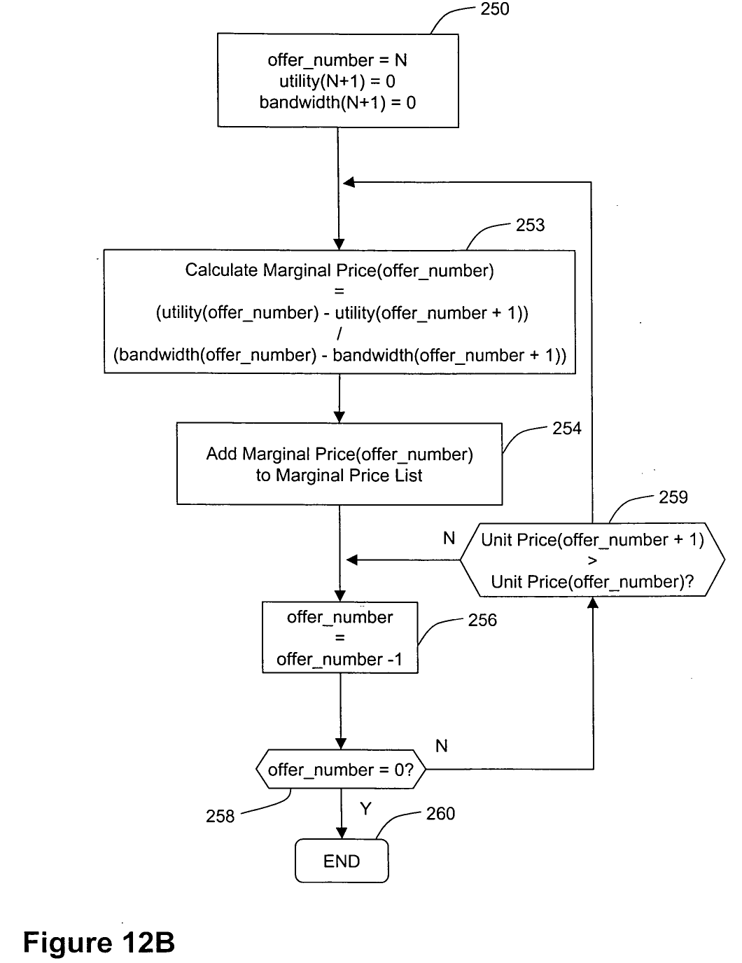

FIG. 12A shows a unit price calculation process carried out in a second embodiment of the present invention;

FIG. 12B shows a marginal price calculation process carried out in the second embodiment;

FIG. 13 shows offer data generated in the second embodiment; and

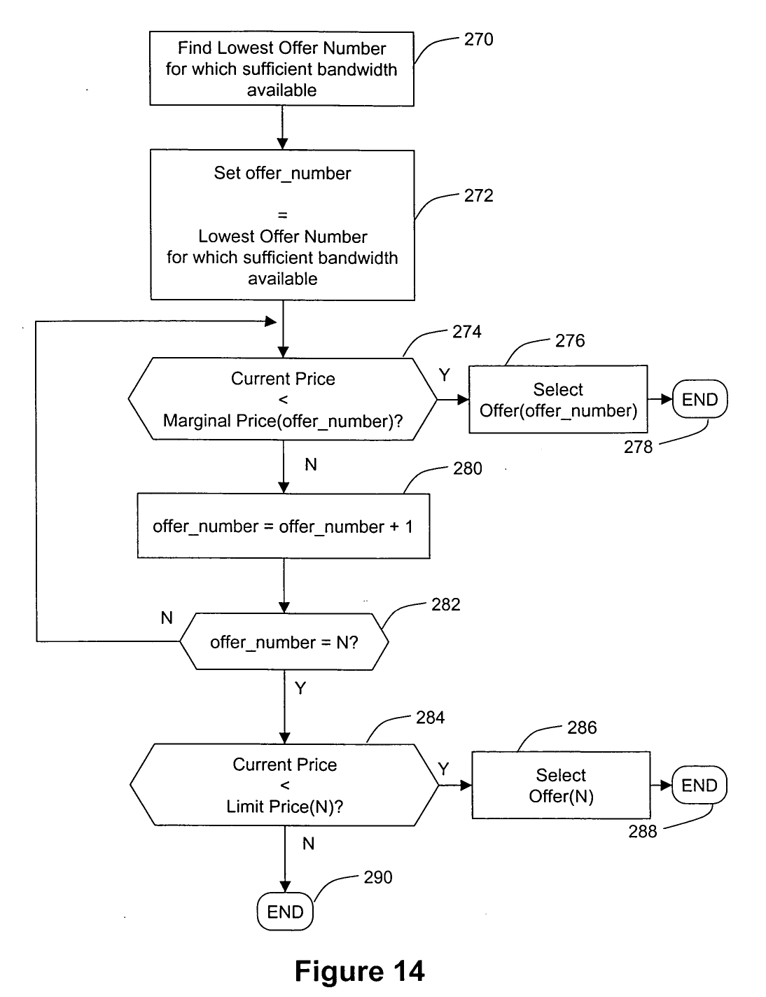

FIG. 14 shows an offer selection process used in the second embodiment.

FIG. 1 shows an internetwork comprising a content provider's local area network 100, a regional cable network 140, a regional Digital Subscriber Loop network 180, and a portion of the global Internet 120 which interconnects all three.

The content provider's network 100 comprises a content provider's Web server 102 and origin video server 104, an Internet router 106 and a LAN 108 interconnecting them.

The regional cable network is illustrated in more detail in FIG. 2. The regional cable network 140 comprises a hybrid fibre/co-axial (HFC) cable network 142, a regional headend 170 which connects the regional cable network to the global Internet 120 via an Internet link 172, a regional fibre network 150, a caching network 144, a Layer 4 switch 148 and a Cable Modem Termination System (CMTS) 146 which interconnects the Layer 4 switch 148 and the HFC cable network 142. The Layer 4 switch interconnects the regional fibre network 150, the caching network 144, and the CMTS 146. A suitable CMTS is the Cisco uBR 7246 which operates in accordance with a pre-standard version of the DOCSIS (Data Over Cable Service Interface Specification) standard version 1.1. The Cisco uBR 7246 also schedules IP packets which transit it in accordance with the value of the so-called Differentiated Services (DS) field in the IP packet header (see the Internet Engineering Task Force's Request For Comments (RFCs) 2474 and RFC 2475 for details of the DS field).

The HFC network 142 comprises a large number of sets of user equipment (152-156), a plurality of co-axial cable networks 157 serving around 700 homes each, a fibre ring 158, and a number of fibre nodes 160, each of which connects the fibre ring 158 to one of the co-axial cable rings 157. Each set of user equipment (152-156) comprises a Toshiba PCX 1100 cable modem 154 (a pre-standard DOCSIS 1.1-compliant cable modem), a Personal Computer (PC) 152, a cable 153 leading from the modem 154 to the PC 152, a cable 155 extending from each set of user equipment to a tap 156 on the co-axial cable ring 157.

The caching local area network 144 comprises an agent server A1, a content file caching server C1, a shaper/marker 164, a bandwidth broker computer B1, and a Local Area Network 162 which interconnects them. The Local Area Network 162 operates in accordance with the Institute of Electrical and Electronics Engineers (IEEE) 802.3 standard at a rate of 100 Mbits⁻¹. The 155 Mbits⁻¹ Lucent Access Point 1000 (AP1000) supplied by Lucent Technologies Inc., 600 Mountain Avenue, Murray Hill, N.J., USA provides a suitable shaper/marker ability.

In accordance with a first embodiment of the present invention, the CMTS 146 is configured as follows. Three diff-serv codepoints (say 001010, 010010, and 011010) are chosen to represent top-priority traffic, mid-priority traffic and low-priority traffic respectively. Best-effort traffic (which is provided with a lower quality of service than low-priority traffic) carries the diff-serv codepoint 000000. The CMTS/IP Router 146 is able to offer each type of traffic simple priority over traffic of the next lowest level of priority.

The IP router component of the headend 170 is configured to reset (to 000000) the DS fields of packets arriving over the Internet link 172 which have their DS field set to a value which is equated to any priority level other than best effort.

The agent server computer A1 is provided with a HyperText Transfer Protocol client program which is configured to use the caching server computer C1 as a proxy (in other words, HTTP requests from the agent server computer will be received by the caching server computer C1 and forwarded if the caching server computer C1 itself cannot satisfy the request. HTTP responses to those requests will be received by the caching server computer C1 and forwarded to the agent server computer A1).

The regional Digital Subscriber Loop Network (FIG. 3) comprises a user's personal computer 10, an ATM network 2, a cable 12 connecting the user's PC 10 to the ATM network 2, an Internet Service Provider's (ISP's) local area network 4, a Broadband Access Server (BAS) 6, an ATM network link 5 which connects the BAS 6 to the ATM network 2 and an ISP network link 7 which connects the BAS 6 to the ISP's local area network 4. In the present embodiment the BAS is provided by a modified Nortel Networks Shasta 5000 Broadband Service Node. The ISP's local area network 4 is connected to the Internet 8 via an Internet link 9.

The ATM network 2 comprises a large number of sets of user equipment (11, 13 14), pairs of copper wires 16 extending from each set of user equipment (11, 13, 14) to a local exchange 20, exchange-housed equipment (17,18) housed in the local telephone exchange building 20 and a wide-area switched network 22 which connects a plurality of such DSLAMs 18 (there is normally one or more DSLAMs per exchange building, only one exchange building is shown in the drawing) to the BAS 6. As will be understood by those skilled in the art, the exchange-housed equipment includes a Digital Subscriber Line Access Multiplexer (DSLAM) 18 shared between many users and, for each pair of copper wires 16, a splitter unit 17 which terminates the pairs of copper wires 16. The splitter unit 17 is effective to send signals within the frequency range used for normal telephony to the Public Switched Telephone Network (not shown) and to send signals in higher frequency bands to the DSLAM 18. Each set of user equipment (11, 13, 14) comprises a splitter unit 14 in a customer's premises which incorporates an Asymmetric Digital Subscriber Line (ADSL) modem 13. The splitter unit 14 is effective to send signals within the frequency range used for normal telephony to the user's telephone 11 and to send signals in higher frequency bands to the ADSL modem 13. The ADSL modem 13 represents the network termination point of the ATM network 2. Cable 12 leads from the modem 13 to the PC 10.

The ISP's local area network 4 comprises an IP router 24, a cache computer C2, an agent computer A2, a bandwidth broker computer B2, and a Local Area Network 30 which interconnects them. The previously mentioned Internet link 9 is connected to the IP router 24. The Local Area Network 30 operates in accordance with the Institute of Electrical and Electronics Engineers (IEEE) 802.3 standard at a rate of 100 Mbits⁻¹.

The caching computer C2 offers the differentiated services extensions to the UNIX sockets interface, or any other programming interface that enables the setting of the so-called Differentiated Services (DS) field in the IP packet header (see the Internet Engineering Task Force's Request For Comments (RFCs) 2474 and RFC 2475 for details of the DS field).

The above-mentioned modification to the BAS 6 is the addition of software to the BAS 6 which controls the BAS 6 to offer different types of service to packets it receives in dependence upon the value of the DS field contained within those packets. In the present embodiment the BAS 6 offers a guaranteed (i.e. reserved bandwidth) service to packets whose DS field is set to 111100 and a best-efforts service to other non-control packets.

That capacity, the capacity of the ISP link 7 and the ATM network 2 is sufficient to ensure that the rate of transmission of a stream of packets between the caching computer C2 and the personal computer 10 is determined by the BAS 6.

It is to be understood that each of the elements of the internetwork (FIG. 1) operates in accordance with version 6 of the Internet Protocol (IP).

In accordance with a first embodiment of the present invention, the ATM network (FIG. 3) is configured by the ATM network operator as follows. Firstly, an ATM permanent virtual circuit (PVC) is configured between the BAS 6 and each of the customer modems (13) it serves. The PVC is a constant bit rate (CBR) connection whose peak cell-rate is set to 2 Mbits⁻¹. The ATM network operator also configures each PC 10 with an IP address. Thereafter a table associating the IP address of each PC with a label that identifies the PVC which leads to that PC 10 is created in the BAS 6 by manual or automatic methods that are well-known to those skilled in the art.

In a conventional manner, the BAS 6 receives a frame constructed in accordance with the link-layer protocol used over the ISP link 7. The link-layer header and/or trailer is then removed from the frame to leave a packet constructed in accordance with the Internet Protocol.

As explained above, the BAS 6 forwards the packet in a manner which depends upon the DS field of the IP packet header. Thus, a packet may be provided with an assured service (where bandwidth is reserved for the delivery of the content file, or a best efforts service. On sending packets over the interface, a (Point-to-Point Protocol) PPP link-layer interface header and trailer are added a frame constructed in accordance with the PPP link-layer protocol. The frame thus constructed is then passed through the ATM Adaptation Layer 5 (AAL5) segmentation process in which it is split into ATM cells and sent onto the ATM PVC connection.

Similar processes are carried out for each packet being received from the link-layer interface to the ISP link 7.

The router 24 is configured to reset (to 000000) the DS fields of all packets arriving over the Internet link 9.

Returning now to FIG. 1, the content provider's Web server computer 102 is provided with a content classifier program, a web server program, a login response program, and a high-level quality of service specification program (quality of service is a term used in the communications art to mean the quality of communication service and is often abbreviated to ‘QoS’). It is to be understood that one or more of these programs may be provided by a provider of a content delivery management service which provider might also operate the agent computers A1 and A2.

The web server program controls the Web server computer 102 to send web-pages requested by a user to that user and to gather information about users in order to enable the quality of the service provided to a user to depend upon the user's identity. In the present embodiment, this is achieved by asking users to fill in a HyperText Mark Up Language (HTML) form in order to register with the web-site.

The form asks the user for a user name and password and various other data such as the user's age, gender, nationality and occupation category. The information provided is used to assign a user to a user class (e.g. Gold, Silver, Bronze). A table giving the class of each user is stored at the Web server 102. Those skilled in the art would be able to write a suitable Web server program.

When run, the high-level QoS specification program controls the Web server computer 102 to prompt the content provider to provide a high-level QoS specification (FIG. 4) for each of a number of content classes defined by the content provider. The content provider is expected to define a number of commercial classes and then expected to organise its content files into content classes which reflect both the commercial classification given to the content file by the content provider and the value of a ‘nature of content’ parameter indicating the susceptibility of the content to a drop in the quality of service of delivery of the content file. The ‘nature of content’ parameter takes one of a predetermined list of values suggested by the provider of the content delivery management service. As can be seen from FIG. 4, each high-level QoS specification is provided with a content class name (top row), a nature of content parameter (leftmost column), and for each user class (middle column) a value scaling factor (rightmost column) Those skilled in the art will have no difficulty in creating a high-level QoS specification program that allows a content provider to generate such QoS specifications.

In a configuration phase, the above-mentioned content classifier program controls the computer to prompt the user to enter:

a) the names of the content classes into which the content provider has organised its content files; and

b) rules for identifying the content class to which each content file stored on the origin video server 104 belongs, given the Universal Resource Locator (URL) of that content file. For example, all files in the directory named ‘video/latest/general’ could be placed in the content class ‘latest_release_general_videos’. The mapping from the URL to the commercial class in that case might be represented as:

Rtsp://www.cp.com/video/latest/general/*.* ->latest_release_general_videos

The content classification program is a Common Gateway Interface (CGI) script and is accessible via the URL (for example) http://www.cp.com/cgi_bin/classifier. The URL of the content file to be classified can be passed as a parameter of, for example, an HTTP GET request. On receiving such a request, the content classification program returns an indication of the content class into which the content file is classified, together with the an indication of where the relevant high-level QoS specification (FIG. 4) for that content class is to be found. Those skilled in the art would easily be able to write a program to create a classifier operating in the above way.

The content provider also creates a high-level QoS specification file for each content class at a URL having a predetermined relationship to its domain name—for example the content provider owning the domain name cp.com might store its high-level QoS specification file for the commercial class ‘latest_release_general-videos’ at:

http://www.cp.com/qospolicy/latest_release_general-videos.txt

The content provider then includes the URLs pointing to its high-level QoS specification files in the list of files which it wishes to be copied to caching servers such as caching server C1 in caching network 144 in the regional cable network (FIG. 2) and caching server C2 in Internet Service Provider network 4 in the DSL regional network (FIG. 3). As will be understood by those skilled in the art, content distributors offer a service in which they copy specified files from an origin server to caches around the world. In the present embodiment, use of such a service results in the content files stored on origin video server computer 104 being copied to the caching servers C1 and C2, together with the content provider's high-level QoS specification files. As will also be understood by those skilled in the art, the content files will often be accompanied by metadata files. For example, the program which generates ReaI™ video files from raw video data also generates an ‘ASM’ file. The metadata file used in the present embodiment (FIG. 5) includes the file name (first row), type of media (e.g. audio, video or text) (second row), format (e.g. RealServer 8, H.261 etc.) (third row), the duration of the video (fourth row) and the data-rates at which the video is playable (fifth row). More generally, the content provider might be asked to provide a session description file for each of its content files stored at the cache.

The login response program comprises a CGI script which is run on receipt of a login request from a registered user of the web server 102. The CGI script controls the web server 102 to read the user name from the received HTTP GET request and retrieve the associated user class. The program then further controls the web server 102 to send an indication of the IP address currently being used by the user and the retrieved user class to an agent computer identified in the received login request.

Each of the caching computers C1 and C2 is provided with a plug-in program (again this might be provided by the provider of a content delivery management service) which causes login requests containing a registered client indication to be forwarded to the appropriate web server (e.g. 102) along with an address of an agent computer associated with that caching computer (for example, in the present embodiment, caching computer C1 includes the address of agent computer A1). The plug-in program further controls the caching computer to respond to a content file request having a registered client indication by forwarding a content file parameters message and a copy of the session description file (e.g. FIG. 5) associated with the requested content file to the associated agent computer (e.g. A1).

FIG. 6 shows a utility curve which indicates how the value U(x) of bandwidth x varies with the amount of bandwidth provided. It will be appreciated that the value placed on a delivery by a purchaser of the service of making that delivery will depend upon who is making the delivery, who is receiving the delivery, the quality of that delivery (in this particular example, quality corresponds to the amount of bandwidth provided) and the nature of the content file which is being delivered. However, in the present embodiment, the provider of the content delivery management service generates data defining a utility curve representing the variation of utility with bandwidth for each combination of nature of content and format. It will be realised the nature of content parameter corresponds to the leftmost column of the high-level QoS specification and that the ‘format’ parameter corresponds to the Format field of the metadata file (FIG. 5—third row). Once generated, the utility curves are stored in each of the agent computers A1 and A2 in such a way that the utility curve for a given nature of content/format combination can be easily retrieved.

FIGS. 7 to 10 illustrate the operations carried out by the customer's PC 1 52, the content provider's origin Web server 0, agent server A1, caching server C1 and bandwidth broker B1 in carrying out the method of the present embodiment. In fact, the steps of FIGS. 7 and 8 carried out by the personal computer 152 are carried out under the control of a conventional browser program such as Netscape's Navigator version 4. (It is to be understood that similar processing would be carried out by PC 10, agent computer A2 and caching computer C2 were the user of PC 10 connected to the DSL network (FIG. 3) to browse in a similar way).

FIG. 7 shows the steps involved when a previously registered user at PC 152 browses the home page of the content provider. The home page includes a form as provided for by HyperText Mark Up Languages HTML 2.0 and above. As will be understood by those skilled in the art, the form as presented to the user has text fields into which the user must enter his user name, and a submit button. The HTML file representing the web-page will also contain a URL which points to a Common Gateway Interface script (i.e. an executable program) and a registered-client indication (not displayed to the user) that indicates the web-page has been generated for a registered client of the caching server operator. When the user clicks on the submit button, the browser program running on the PC 152 sets up a Transmission Control Protocol (TCP) connection to the Layer 4 switch (FIG. 2—148) and sends a HyperText Transfer Protocol (HTTP) GET request across that TCP connection (step 1). The layer 4 switch 148 is configured to redirect all requests destined for the default ports used for each content file type to the caching computer C1 (e.g. port 80 for http and port 554 for rtsp). This avoids the browser program stored on the PC 152 having to be configured to point to the caching computer C1. The GET request is accompanied by the user name and the registered client indication. The Layer 4 switch 148 recognises the TCP port value in the GET request and hence forwards the request to the caching server C1. The plug-in program on the caching server C1 recognises that the request must be forwarded to the origin server 0 and, since the registered client indication is present, appends an indication of the agent server A1 and then sets up a further TCP connection to the origin Web server 0 and passes the modified GET message across that connection (step 2).

The origin Web server 0 receives the GET message and the appended user name, client indication, and agent identifier. In response, it runs the associated CGI script which causes it to:

a) fetch from the user database the user class, and then send that user class and an indication of the user's current Internet address to the agent computer A1 identified by the agent identifier in the received message (step 3); and

b) send an HTML file representing a registered user menu page to the PC 152 (step 4). The HTML file includes one or more hyperlinks to content files previously copied to the caching server C1 by a content distributor as described above.

On receiving the user class message, the agent server A1 stores the user class along with the user's current IP address.

Once it is received, the user's PC 152 presents the HTML file as a registered user menu page on the screen of the PC 152. The registered user menu page includes one or more hyperlinks which are associated with content files stored on the caching server C1.

Turning now to FIG. 8, on the user selecting one of those hyperlinks an RTSP SETUP request is sent to the Layer 4 switch 148. As before, the HTML file includes a HTML form which causes a registered client indication to be included in the SETUP request. The Layer 4 switch 148 recognises the TCP port in the request and hence forwards the request to the caching server C1 (step 5). On receiving the SETUP request, the plug-in program at the caching server C1 responds to the presence of the registered client indication by controlling the caching server C1 to send:

a) a content file transfer parameters message to the agent server A1 which includes the URL of the requested content file, values of the user's TCP port and IP address, the origin server's IP address and the caching server's port and IP address. The caching server in the present embodiment provides transparent caching—as will be understood by those skilled in the art, this results in the flow between the caching server and the client PC being characterised by the origin server IP address and the caching server's port number; and

b) the metadata file (FIG. 5) associated with the requested content file.

On receiving the content file transfer parameters message and the metadata for the requested content file, the agent sends an HTTP GET request to the classifier program at the Web server 102 having the URL of the content file as a parameter (step 7). The classifier program controls the Web server 102 to respond by giving the URL of the relevant high-level QoS specification (step 8). Since the URL of the high-level QoS specification is returned as an embedded object, the HTTP client at the agent computer A1 is automatically re-directed to fetch the high-level QoS specification file (FIG. 4) previously stored at the cache by the content distributor (step 9). The agent computer A1 stores the high-level QoS specification file.

The agent computer then selects the utility curve in its store which corresponds to the nature of content parameter in the high-level QoS specification (received in step 9) and the format (received as part of the metadata file transferred in step 6).

Thereafter, the utility value for each of the possible output data-rates of the content file (those data-rates having been obtained from the metadata file), is found.

The agent computer A1 thereafter looks up the stored user class (e.g. Gold, Silver or Bronze—which it received in step 3) associated with the IP address received in the content file transfer parameters message (received in step 6).

Next, the agent computer A1 finds the scaling factor for the class of service (which, in the present embodiment directly corresponds to the user class) from the high-level QoS specification file received in step 9. The utility values for each of the possible output data-rates obtained from the utility curve (for the indicated nature of content/format combination) are then scaled accordingly. The utility values are then incorporated in a Premium Session Request (FIG. 9) which is forwarded (FIG. 10—step 10) to the bandwidth broking computer B1.

In more detail, FIG. 9 shows that the Premium Session Request data sent to the bandwidth broking computer B1 comprises, session information (left-hand column) three offers (second and third columns), and offer numbers to be associated with the offers. In normal circumstances, offer number one will provide the lowest price per unit bandwidth, with the price offered per unit bandwidth increasing as the offer number rises. Each of the three offers comprises a data-rate (central column) and an associated utility value (right-hand column). The session information comprises the source IP address of the content file delivery, the TCP port associated with the delivery, and the destination IP address of the content file delivery. From the above description of the present embodiment, it will be understood that each utility value in the premium session request depends on:

a) the ‘nature of content’ parameter assigned to the ‘gladiator.rm’ video by the content provider. By having content providers assign such a ‘nature of content’ parameter to their content files, the agent computer operated by the organisation offering the content delivery management service is able to select a utility curve that reflects the susceptibility of the content file to a reduced quality of delivery;

b) the format parameter read from the metadata file is also reflected in the utility curve selected by the agent computer. By using the format parameter, the content delivery management service is able to select a utility curve that reflects the susceptibility of the format to a reduced quality of delivery;

c) the bandwidth offered for the delivery the commercial class assigned to the ‘gladiator.rm’ video by the content provider is subsequently reflected in choosing the relevant points from the selected utility curve;

d) The commercial value placed on the delivery by virtue of the commercial nature of the video is reflected in the scaling factor used in processing the selected points to obtain the utility values of FIG. 9; and

e) the class assigned to the user by the content provider is also reflected in the scaling factor used in processing the selected points to obtain the utility values of FIG. 9.

On receiving the premium session request, the bandwidth broking computer B1 carries out the offer selection process illustrated in FIG. 11. Firstly, an offer_number variable is initialised to zero and each element of a selected_offer two element array is set to zero (step 204). The first element of the selected offer array represents the offer_number and the second element represents the surplus found in respect of that offer (surplus is explained below). Next, an offer evaluation process (steps 206-216) is carried out. The offer evaluation process begins with the incrementing of the offer_number variable (step 206). Thereafter, the data-rate component of the offer indicated by the offer_number variable is compared to the available bandwidth (step 208). If the data-rate indicated exceeds the available bandwidth then the offer evaluation process ends. If, on the other hand, the available bandwidth exceeds the data-rate specified in the offer, then the difference (here referred to as ‘surplus’) between the utility value component of the offer and the cost (in the hybrid fibre/co-axial (HFC) cable network (FIG. 2—142)) of an amount of bandwidth equal to the data-rate specified in the offer is calculated (step 210). A check is then made that the surplus is greater than the maximum surplus so far encountered in the offer selection program (step 212). If the surplus is less than the maximum surplus, the offer evaluation process for the current offer ends. If, on the other hand, the surplus is greater than the maximum surplus, the selected_offer two element array is updated with the associated current value of the offer_number variable and that surplus. Each time the offer evaluation process ends, a test is made to find whether one or more offers in the Premium Session Request (FIG. 9) remain to be considered (step 218). If all the offers in the Premium Session Request have been considered then the offer selection program ends (step 222). If, on the other hand, one or more offers remains to be considered then the offer evaluation process (steps 206-216) is repeated. If the surplus element of the two element array is still zero at the end of the offer selection process then the content file is not delivered to the user.

Having selected the offer to be applied to the content file transfer to the requesting user, the bandwidth broker computer B1 sends (step 11) a message indicating the source and destination IP addresses and TCP ports of the content file transfer and a Diff-Serv marking associated with the selected bandwidth level to the marker 164. It will be understood that the source and destination IP addresses and TCP ports of the content file transfer are those included with the premium session request received from the agent computer A1 (FIG. 10—step 10).

In the meantime (or, in some embodiments, in response to the selection of an offer by the bandwidth broker computer B1), the caching server C1 sets up a streaming session with the user's PC 152. The caching server divides the content file into packets and starts sending (step 12) those packets to the user's PC 152 via the marker 164. Once the marker 164 has received the Diff-Serv marking message from the agent server A1, it recognises packets belonging to the content file transfer (the IP address and User Datagram Protocol (UDP) port in the marking instruction will match the corresponding parameters in packets belonging to the content file transfer—note that, since it is operating as a transparent cache, the caching server operates to use the origin server's address as the source address of the packets). The marker marks packets so recognised with a Diff-Serv codepoint that corresponds to the selected bandwidth.

The marked packets are forwarded to the CMTS 146 which will schedule the packets sent from it in accordance with the diff-serv codepoints they contain.

It will be seen how the above embodiment uses only a few sets of utility data in providing a different quality of service to many different content file deliveries. This reduces the effort involved in generating utility data.

A number of alterations can be made to the above embodiment without departing from the scope of the present invention. Such alterations include:

i) the use of version 4 of the Internet Protocol instead of version 6 of that protocol;

ii) in the above embodiment packet marking is carried out by the caching computer C2 in the DSL regional network (FIG. 3) and by the shaper/marker (FIG. 2—164) in the cable network. Packet marking could, for example, be carried out by the caching computer, a shaper/marker or by a layer 4 switch (FIG. 2—148) in many different types of regional network;

iii) in the above embodiment a full set of utility curves is stored at each agent computer (A1, A2). However, the utility curves could be stored at a single computer operated by the provider of the content delivery management service and downloaded to the agent computer (A1, A2) following receipt of the content file transfer parameters message and metadata file (FIG. 8—step 6). The utility curve may then be stored at the agent computer (A1, A2) for future use;

iv) in the above embodiment each regional network has a agent computer (A1, A2). However, in alternative embodiments, an agent computer is shared between two or more regional networks;

v) in the above embodiment the utility curves give the variation of utility value with supplied bandwidth. In alternative embodiments, the utility curves may represent the variation of utility value with latency or some other quality of service parameter (for example: jitter, packet loss, short term burst features, minimum bandwidth, average bandwidth). In yet further embodiments, the utility curves may represent the variation of utility value with two or more quality of service parameters—for example the utility data might provide a utility value associated with values of both supplied bandwidth and latency;

vi) in the above embodiment the purchaser provides data enabling the selection and processing of utility curves to generate the Premium Session Request from a request. This data is stored for future use. In alternative embodiments, the purchaser might provide such data in response to each request—this would still reduce the burden placed on the purchaser in comparison to the known prior-art (where the purchaser would be required to provide the utility curve on each request);

vii) A ‘cookie’ stored at the registered client's computer could be used to identify the user rather than using an HTML form;

viii) The above embodiment applied to content data delivery, it might equally well apply to other forms of packet telecommunication such as packet telephony.

ix) The purchaser might provide its own curves for new ‘natures of content’ of new formats. The curves could be retrieved from the origin server when first needed and cached by the agent;

x) The ‘nature of content’ need not be specified by the content provider (in which case only the format is used to distinguish the utility curve that should be used). The consequence of this is that the content provider indicates that they are prepared to pay the same for more and less QoS demanding content. If the same (averaged) utility curve is used then the result is that the most QoS demanding content may be delivered even though a negative surplus may actually returned (i.e. it costs more to deliver than it is really worth to the end user). Also there is a risk that the less QoS demanding content will be delivered in a way that does not maximise the returned surplus.

xi) the ‘nature of content’ might be specified in the metadata file (FIG. 5). In this case content is classified only on the commercial classification. But at the time that the session request is made different curves are selected. If the content provider wants to make sure that films and plays are sent at the same user perceived quality then it would need to create two commercial classes and set the vertical scaling factors appropriately.

xii) The utility curves might be subdivided into regions of different perceptual quality. These might for example be labelled with keywords such as ‘Broadcast Television quality’ or ‘videotape quality’ or by Mean Opinion Scores (1-5). The quality of service specification program provided on the content provider's web-server might permit the content provider to specify a minimum acceptable perceptual quality or an acceptable range of values for perceptual quality (a perceptual quality indicator). When the bandwidths supported by a particular item of content are looked up, these can then be checked against the perceptual quality indicator and a premium session request would only be constructed if a match could be found. This allows the high level qos specification to control perceptual quality without having to specify specific bandwidths. A similar effect could be achieved by ensuring that all content items within a class are encoded for transmission within a carefully chosen range of rates. However even in this case a perceptual quality indicator could provide a useful check useful check in case certain items of content have been included within a content class with very different bandwidths from other items of content in the same class. It should be noted that the Vertical scaling factor is based on a maximum utility value—i.e. the value that the content provider places on perfect perceptual quality.

xiii) In the above embodiment, a content delivery which could be made at three discrete bandwidths was described. The embodiment also applies to deliveries which may be made over a continuous range of bandwidths (such as data file deliveries).

xiv) The evaluation process (FIG. 11) might be carried out at regular intervals by the bandwidth broker computer in response to changes in available bandwidth and spot price of bandwidth. In this case, a Diff-Serv marking message might be sent in response to each evaluation calculation carried out by the bandwidth broker computer. The evaluation might be carried once every few seconds.

xv) The offer number in the premium session request may be implicitly represented by the order of the offers.

xvi) In the above-described embodiment, the calculation of the offer data is carried out at the agent computer. In other embodiments, the stored utility curves may be sent to the user's computer and the calculation carried out there.

A second, preferred embodiment of the present invention will now be described. The second embodiment operates similarly to the first embodiment save for:

a) the agent computer carrying out an additional marginal price calculation and producing a Premium Session Request including marginal prices; and

b) the bandwidth broker computer carrying out a different offer selection process in response to the modified Premium Session Request.

The additional marginal price calculation carried out by the agent computer is illustrated in FIGS. 12A and 12B. Having generated the offer data (second and third columns of FIG. 9) in the same way as in the first embodiment, the unit price list generation process illustrated in FIG. 12A is carried out.

The unit price list generation process begins with the setting of an offer_number variable to a value equal to the number of offers contained within the offer data (step 230). It will be realised that this results in the offer_number variable being given a value equal to the offer_number relating to the lowest bandwidth purchase offer.

A unit price calculation process (steps 232 to 236) is then carried out. The unit price calculation process begins with the division of the price that the purchaser is prepared to pay for the amount of bandwidth specified in the offer by that amount of bandwidth (step 232). The result of the calculation is stored in association with the offer_number (step 234). The offer_number variable is then decremented (so that it points to the offer having the next lowest bandwidth associated with it (step 236).

Following the unit price calculation process (steps 232 to 236), a test (step 238) is carried out to find whether all of the offers contained within the offer data have been considered. If offers remain to be considered then the unit price calculation process is repeated. If, on the other hand, all offers have been considered then the unit price of zero is associated with an imaginary offer number 0 (step 239).

Thereafter, a marginal price list generation process (FIG. 12B) is carried out. The process begins with the initialisation of an offer_number variable to a value equal to the number of offers contained within the offer data and the setting of two parameters for a fictitious offer for zero bandwidth at zero cost (step 250). It will be realised that, as in the unit price list generation process, the setting of the offer_number variable results in the offer_number variable being given a value equal to the offer_number relating to the lowest bandwidth purchase offer.

A marginal price calculation process (steps 253 to 256) is then carried out. The process begins with the price at which the calculation (step 253) of the price at which a purchaser would choose to change between offers (known as a marginal price). It will be understood that where the price rises past the marginal price, the purchaser will choose to drop to the lower level of bandwidth (i.e. a higher offer number). Where the price falls below the marginal price, the purchaser will wish to increase the amount of bandwidth purchased (i.e. move to a lower offer number). The marginal price is found by dividing the difference in utility between the two offers by the difference in bandwidth between the two offers. The calculated marginal price is stored in relation to the lower of the two offers to which it relates (step 254). In the final step of the marginal price calculation process (steps 253 to 256), the offer_number variable is decremented (step 256).

Each time the marginal price calculation process ends, a test is carried out to find whether the offer_number variable has fallen to zero (step 258). If it has, then all marginal prices have been calculated and the marginal price list generation process ends. If it has not, then a test (step 259) to find whether the unit price for the previous offer is higher than the unit price for the current offer is performed. Normally, where bandwidth is being rationed by price this test will be met. If the test is met, then the marginal price calculation process (steps 253 to 256) is repeated. If, on the other hand, the test is not met then the offer_number is decremented again (step 256). Thereafter the same actions are performed as are performed at the end of the marginal price list calculation process (steps 253 to 256).

The Premium Session Request sent in accordance with the second embodiment is illustrated in FIG. 13. It will be seen that the Premium Session Request is identical to that of the first embodiment (FIG. 9) save for the addition of a unit price column which carries the unit prices calculated in the unit price list generation process (FIG. 12A) and a marginal price column which carries the unit prices calculated in the marginal price list generation process (FIG. 12B).

On receiving the Premium Session Request, the bandwidth broking computer B1 carries out an offer selection process (FIG. 14). Initially, in step 270, the lowest offer number for which sufficient bandwidth is available is found. Once that offer number has been identified an offer_number variable is set to that offer number (step 272).

Thereafter, an offer evaluation process (steps 274 to 280) is carried out. The offer evaluation process begins with a test (step 274) to find whether the current price is less than the marginal price above which a purchaser would choose not to purchase the amount of bandwidth associated with the current offer but instead to purchase the lower amount of bandwidth associated with the next offer. If the current price is less than the marginal price then the current offer is selected (step 276) and the offer selection process ends (step 278). If the price is higher than the marginal price, then the offer_number variable is incremented (step 280). The offer evaluation process (steps 274 to 280) then ends.

Next, a test (step 282) is carried out to find whether the last offer has been reached. If it has not, the offer evaluation process (steps 274 to 280) is repeated. When the last offer has been reached a final offer evaluation process (steps 284 to 290) is carried out. That process begins with a test to find whether the current price is less than the unit price associated with the last offer. If the price is higher than the unit price, then it follows that the purchaser does not wish to purchase any bandwidth. Hence, the final offer evaluation process ends (step 290). If the price is lower than the unit price, then the final offer is selected (step 286) and the process ends.

Having selected an offer, the second embodiment operates in a similar way to the first embodiment.

It will be seen how the second embodiment reduces the complexity of the evaluation process carried out by the bandwidth broker computer. This is especially beneficial in cases where the evaluation process is to be carried out by a device that has limited processing power.

A number of alterations can be made to the second embodiment without departing from the scope of the present invention. Such alterations include those mentioned in relation to the first embodiment and also:

i) The marginal prices in the above case were calculated by the agent computer and relate to the transition from one offer number to offer closest to it. It is possible, for example, that the intermediate offer in FIG. 13 will become unavailable. To provide for this situation, the bandwidth broker computer may use the supplied utility values to calculate the marginal price relating to the transition between the first and third offers. More generally, by supplying the bandwidth broker computer with a utility/bandwidth pair for every offer, the bandwidth broker computer is able to calculate marginal prices for all possible transitions. Alternatively, the marginal price between, for example, the first and third bandwidths can be calculated from the marginal prices between the first and second bandwidths and between the second and third bandwidths.

ii) The calculation of unit values may reveal that between two offers, the unit values increase with increasing bandwidth. In this case, one of those offers can be specially marked in the Premium Session Request. This only has relevance if bandwidth (e.g.) is being rationed other than by price, and the result of this is that a purchaser is only offered bandwidth below that at which the unit value of bandwidth is maximised (from which one could infer that the application is performing under conditions of distress). If the user is prepared to set values (or maximum prices) for any offers within the range of rising unit values, it follows that he could well benefit from more bandwidth than he has associated with certain price points in his bidding table. If so, those bandwidths would be interpreted as minimum, rather than maximum bandwidths at such prices. The mark indicates whether quantities (e.g. bandwidth) bid in a range of rising unit values are to be interpreted as fixed or alternatively as minima (at the associated prices) with the consequence that full advantage is taken of all available bandwidth at that price.

iii) In cases where the utility function represents the variation of utility with a plurality of QoS factors, marginal prices could be established between a given offer and a plurality of other offers.

1. A method of operating a communications network to allocate resources of said network between users, said method comprising:
storing one or more sets of typical utility data for one or more types of said deliveries over said network;
receiving, from each of a plurality of users, values of one or more utility-influencing parameters for each of one or more data deliveries desired by said user;
generating resource demand data for each of said deliveries in dependence upon said stored typical utility data and said utility-influencing parameters; and
allocating resources of said network between deliveries in dependence on said generated resource demand data.

2. A method according to claim 1 wherein said resource demand data comprises offer data.

3. A method according to claim 2 wherein said storing step involves storing a plurality of sets of utility data and said offer data generation step involves:
selecting one of said stored sets of utility data in dependence upon said utility-influencing parameter value; and
generating said offer data from said selected set of utility data.

4. A method according to claim 1, wherein:
said delivery of data across said network is available at different qualities of delivery;
each set of utility data enables the determination of utility values for each quality of delivery; and
said resource demand data generation step involves:
receiving one or more quality of delivery indications; and
generating said resource demand data by determining a utility value for each indicated quality of delivery.

5. A method according to claim 4 in which said data comprises content data and quality of delivery indications are obtained from metadata automatically generated at the time of generation of said content data.

6. A method according to claim 1 in which said one or more utility-influencing parameters comprise one or more qualitative parameters, each of which is indicative as to which of a plurality of predefined qualitative classes said data belongs.

7. A method according to claim 6 in which said data comprises content data and one or more qualitative parameters comprises one or more nature of content parameters, whose value is indicative of a nature of content class to which said content data belongs.

8. A method according to claim 1 in which said resource demand data generation step involves processing at least one element of said selected set of utility data in a manner which depends upon one or more of said utility-influencing parameters.

9. A method according to claim 8 in which said processing comprises multiplying said at least one element by a scaling factor.

10. A method according to claim 1 in which said one or more utility-influencing parameters comprise one or more susceptibility parameters, whose value is indicative of the susceptibility of the quality of presentation of said content data at the receiver to a reduction in quality of the delivery of said content data.

11. A method according to claim 1 wherein said utility-influencing value provision step comprises:
obtaining from said user conversion data associating values of utility-influencing parameters with delivery characteristics derivable from a delivery request;
storing said conversion data; and
on receiving a delivery request, deriving said delivery characteristics and reading the values of utility-influencing parameters associated with said delivery characteristics.

12. A communications network operable to deliver content files from one or more file sources to one or more receivers, said network comprising:
one or more stores storing content files;
a store storing one or more sets of utility data;
a plurality of user computers, each arranged in operation to provide one or more utility-influencing parameter values associated with a delivery of a content file to one or more receivers; and
means arranged in operation to generate resource demand data from said one or more sets of utility data and said one or more utility-influencing parameters; and
means arranged in operation to allocate resources of said network between deliveries in dependence on said generated resource demand data.

13. A communications network according to claim 12 further comprising:
one or more utility-influencing parameter stores storing values of one or more utility-influencing parameters for each of said content files;
means arranged in operation to receive a request including an identifier identifying content file to be sent;
wherein each of said user computers is arranged in operation to read said utility-influencing parameter stores to find said utility-influencing parameter values for the content file identified in said request.
